(19) United States
(12) Patent Application Publication
(10) Pub. No.: US 2007/0059662 A1
(43) Pub. Date: Mar. 15, 2007

(54) Dental device for preparing a tooth for a crown and for preparing the crown and a method of use

(76) Inventor: Tawfik Bittar, Brooklyn, NY (US)

Correspondence Address: Mr. Tawfik Bittar, 7307 6th Avenue-1st Floor, Brooklyn, NY, 11209, US

(21) Appl. No.: 11/269,029

(22) Filed: Nov. 7, 2005

Related U.S. Application Data
(63) Continuation of application No. 11/202,394, filed on Sep. 12, 2005.

(51) Int. Cl. A61C 1/02; A61C 3/00; A61C 1/16; A61C 5/08

(52) U.S. Cl. 433/98; 433/75; 433/116; 433/218

(57) ABSTRACT

A dental device for preparing a tooth for a crown and for preparing the crown and a method of use. The dental device includes a tooth-preparation portion and a crown-preparation portion. The tooth-preparation portion prepares the tooth for the crown, thereby forming a crown-prepared-tooth, and thereafter, takes measurements of the crown-prepared tooth, thereby forming crown-prepared-tooth measurements. The crown-preparation portion is operatively connected to the tooth-preparation portion and prepares the crown for the crown-prepared tooth based upon the crown-prepared-tooth measurements received from the tooth-preparation portion.

### CROSS REFERENCE TO RELATED APPLICATIONS

The instant application is a Continuation application of application Ser. No. 11/202,394, filed Aug. 9, 2005 by Tawfik Bittar, and entitled DENTAL TECHNICIAN.

### BACKGROUND OF THE INVENTION

A. Field of the Invention

The present invention relates to a dental device, and more particularly, the present invention relates to a dental device for preparing a tooth for a crown and for preparing the crown.

B. Description of the Prior Art

Numerous innovations for devices for preparing a tooth for a crown and devices for preparing the crown have been provided in the prior art. Even though these innovations may be suitable for the specific individual purposes to which they address, they each differ in structure and/or operation and/or purpose from the present invention in that they do not teach a dental device of the present invention for preparing a tooth for a crown and for preparing the crown as heretofore described.

### SUMMARY OF THE INVENTION

Thus, an object of the present invention is to provide a dental device for preparing a tooth for a crown and for preparing the crown that avoids the disadvantages of the prior art.

Briefly stated, another object of the present invention is to provide a dental device for preparing a tooth for a crown and for preparing the crown and a method of use. The dental device includes a tooth-preparation portion and a crown-preparation portion. The tooth-preparation portion prepares the tooth for the crown, thereby forming a crown-prepared tooth, and thereafter, takes measurements of the crown-prepared tooth, thereby forming crown-prepared-tooth measurements. The crown-preparation portion is operatively connected to the tooth-preparation portion and prepares the crown for the crown-prepared tooth based upon the crown-prepared-tooth measurements received from the tooth-preparation portion.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic perspective view of the dental device of the present invention including the tooth-preparation portion of the dental device of the present invention for preparing a tooth for a crown and the crown-preparation portion of the dental device of the present invention for preparing the crown;

FIG. 2 is an enlarged diagrammatic side elevational view of the area generally enclosed by the dotted curve identified by ARROW 2 in FIG. 1 of the tooth-preparation portion of the dental device of the present invention for preparing a tooth for a crown;

FIG. 3 is an enlarged diagrammatic cross sectional view of the area generally enclosed by the dotted curve identified by ARROW 3 in FIG. 2 of the filing bur of the tooth-preparation portion of the dental device of the present invention;

FIG. 4 is an enlarged diagrammatic side elevational view of the area generally enclosed by the dotted curve identified by ARROW 4 in FIG. 1 of the crown-preparation portion of the dental device of the present invention for preparing the crown;

FIG. 5 is a diagrammatic side elevational view of the separating step of the method of utilizing the dental device of the present invention for preparing the tooth for the crown;

FIG. 6 is a diagrammatic side elevational view of the filing step of the method of utilizing the dental device of the present invention for preparing the tooth for the crown; and

FIG. 7 is a diagrammatic side elevational view of the cleaning and post preparing steps of the method of utilizing the dental device of the present invention for preparing the tooth for the crown.

### LIST OF REFERENCE NUMERALS UTILIZED IN THE DRAWING

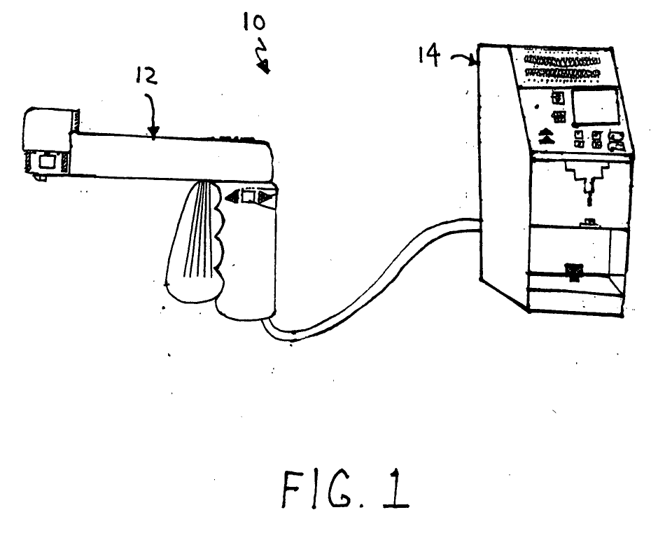

A. Overall—FIG. 1.

10 dental device of present invention for preparing tooth for crown and for preparing crown

12 tooth-preparation portion for preparing tooth for crown, thereby forming crown-prepared tooth and thereafter taking measurements of crown-prepared tooth, thereby forming crown-prepared-tooth measurements

14 crown-preparation portion for preparing crown for crown-prepared tooth based upon crown-prepared-tooth measurements received from tooth-preparation portion 12

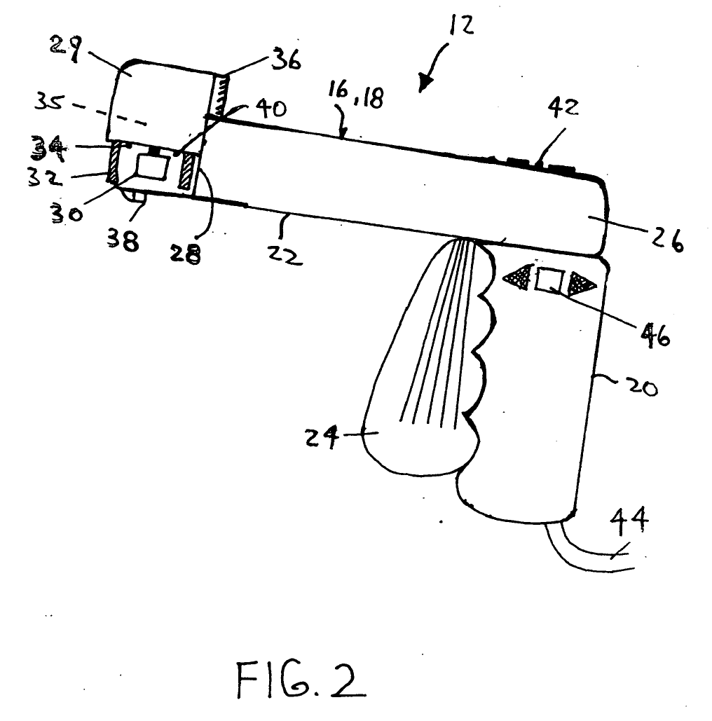

B. Tooth-Preparation Portion 12—FIG. 2.

16 housing

18 pistol of housing 16 for easy handling

20 grip of pistol 18 of housing 16

22 barrel of pistol 18 of housing 16

24 trigger of pistol 18 of housing 16

26 proximal end of barrel 22 of pistol 18 of housing 16

28 distal end of barrel 22 of pistol 18 of housing 16

29 head

30 filing bur of head 29 for receiving and preparing tooth for crown

32 cover of head 29 for containing filings from filing bur 30 of head 29 during filing

34 air and water port of head 29 for supplying air and water to cool filing bur 30 of head 29 during filing

35 motor of head 29

36 vertical-displacement control

38 horizontal-displacement control

40 light of head 29

42 jaw-selection control for treating top and bottom teeth

44 cables for supplying electricity to motor 35 of head 29 and for supplying air and water to air and water port 34 of head 29.

46 dimension input

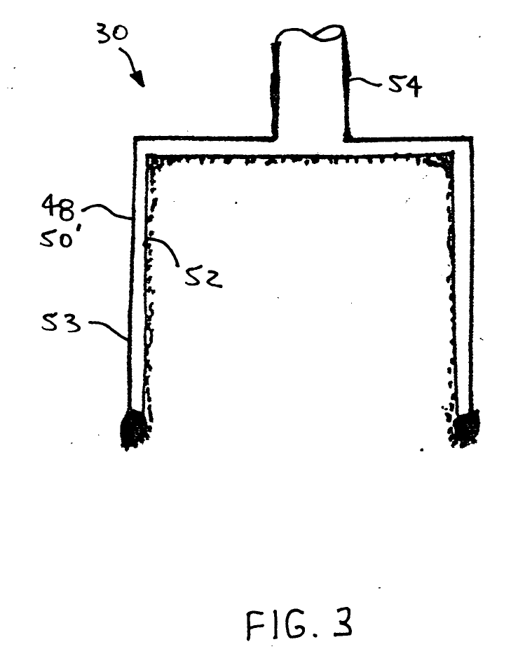

(1) Filing Bur 30 of Head 29—FIG. 3.

48 body of filing bur 30 of head 29

50 inverted cup of body 48 of filing bur 30 of head 29

52 inner surface of inverted cup 50 of body 48 of filing bur 30 of head 29

53 outer surface of inverted cup 50 of body 48 of filing bur 30 of head 29

54 shaft of inverted cup 50 of body 48 of filing bur 30 of head 29

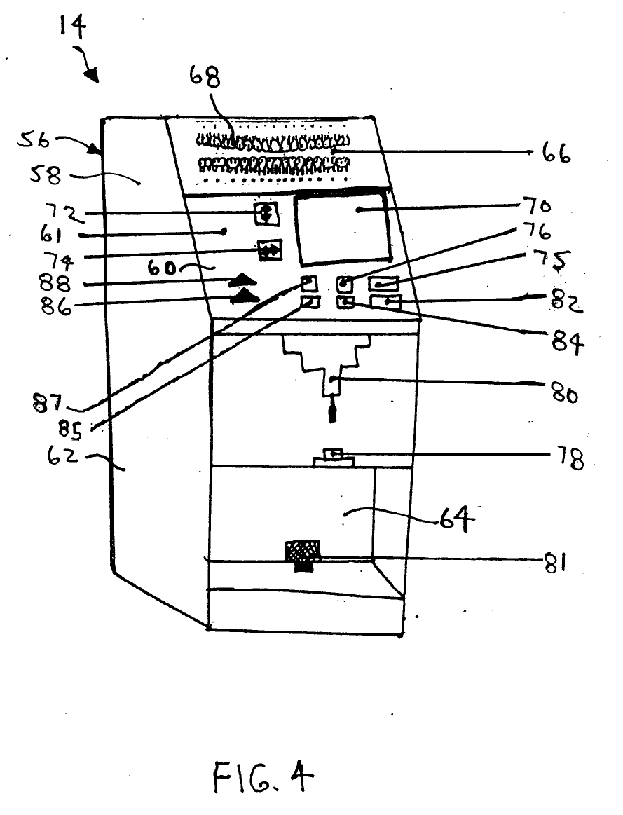

C. Crown Preparation Portion 14—FIG. 4.

56 enclosure for standing upright from floor

58 upper portion of enclosure 56

60 front of upper portion 58 of enclosure 56

61 control panel on front 60 of upper portion 58 of enclosure 56

62 lower portion of enclosure 56

64 front of lower portion of enclosure 56

66 tooth-selection panel for entering number of tooth for which crown is being prepared by touching associated tooth of array of teeth 68 of tooth-selection panel 66

68 array of teeth of tooth-selection panel 66

70 display screen for displaying input data

72 vertical-dimension-input button for inputting vertical dimension

74 horizontal-dimension-input button for inputting horizontal dimension

75 on-off switch

76 enter button for entering data inputted

78 base for holding crown being prepared

80 motor for rotating tool for trimming crown

81 heat source for applying heat during polishing of crown

82 start button

84 data-transmission button

85 input-save button

86 heat source on-off button

87 output-erase button

88 polishing-start button

### DETAILED DESCRIPTION OF THE PREFERRED EMBODIMENT

A. Overall.

Referring now to the figures, in which like numerals indicate like parts, and particularly to FIG. 1, which is a diagrammatic perspective view of the dental device of the present invention including the tooth-preparation portion of the dental device of the present invention for preparing a tooth for a crown and the crown-preparation portion of the dental device of the present invention for preparing the crown, the dental device of the present invention is shown generally at 10 for preparing a tooth for a crown and for preparing the crown.

The dental device 10 includes a tooth-preparation portion 12 and a crown-preparation portion 14. The tooth-preparation portion 12 is for preparing the tooth for the crown, thereby forming a crown-prepared tooth and thereafter taking measurements of the crown-prepared tooth, thereby forming crown-prepared-tooth measurements. The crown-preparation portion 14 is operatively connected to the tooth-preparation portion 12 and is for preparing the crown for the crown-prepared tooth based upon the crown-prepared-tooth measurements received from the tooth-preparation portion 12.

B. The Tooth Preparation Portion 12.

The configuration of the tooth-preparation portion 12 can best be seen in FIG. 2, which is an enlarged diagrammatic side elevational view of the area generally enclosed by the dotted curve identified by ARROW 2 in FIG. 1 of the tooth preparation-portion of the dental device of the present invention for preparing a tooth for a crown, and as such, will be discussed with reference thereto.

The tooth-preparation portion 12 includes a housing 16. The housing 16 is hand-held and is in a form of a pistol 18 for easy handling, and has a grip 20, a barrel 22, and a trigger 24. The trigger 24 of the pistol 18 of the housing 16 is operatively connected to the grip 20 of the pistol 18 of the housing 16. The barrel 22 of the pistol 18 of the housing 16 has a proximal end 26 from which the grip 20 of the pistol 18 of the housing 16 depends, and a distal end 28.

The tooth-preparation portion 12 further includes a head 29. The head 29 extends at the distal end 28 of the barrel 22 of the pistol 18 of the housing 16.

The head 29 includes a filing bur 30. The filing bur 30 of the head 29 is contained dependingly therein and is for receiving and preparing the tooth for the crown.

The head 29 further includes a cover 32. The cover 32 of the head 29 is contained dependingly therein, surrounds the filing bur 30 of the head 29, and is for containing filings from the filing bur 30 of the head 29, yet is transparent for allowing sight of the filing bur 30 of the head 29 during filing.

The head 29 further includes an air and water port 34. The air and water port 34 of the head 29 is contained dependingly therein, is interposed between the cover 32 of the head 29 and the filing bur 30 of the head 29, forward of the filing bur 30 of the head 29, and is for supplying air and water to cool and clean the tooth being prepared and the filing bur 30 of the head 29 during filing.

The head 29 further includes a motor 35. The motor 35 of the head 29 is contained therein, is high speed, and is operatively connected to the filing bur 30 of the head 29 to rotate the filing bur 30 of the head 29.

The tooth-preparation portion 12 further includes a vertical-displacement control 36. The vertical-displacement control 36 controls vertical displacement of the head 29 and associated measurement and is disposed vertically on the head 29.

The tooth-preparation portion 12 further includes a horizontal-displacement control 38. The horizontal-displacement control 38 controls horizontal displacement of the head 29 and associated measurement and is disposed horizontally from the head 29.

The head 29 further includes a light 40. The light 40 of the head 29 is contained dependingly therein, is interposed between the cover 32 of the head 29 and the filing bur 30 of the head 29, rearward of the filing bur 30 of the head 29, and illuminates the filing bur 30 of the head 29 during filing.

The tooth-preparation portion 12 further includes a jaw selection control 42. The jaw selection control 42 is operatively connected to the head 29, causes the head 29 to selectively invert for treating top and bottom teeth, and is controlled by the trigger 24, which when squeezed, frees the head 29 for inversion, and which when released, locks the head 29 in position.

The tooth-preparation portion 12 further includes cables 44. The cables 44 depend from the grip 20 of the pistol 18 of the housing 16, are operatively connected to the crown-preparation portion 14 to transmit the crown-prepared—tooth measurements thereto from the tooth-preparation portion 12, are for supplying electricity to the motor 35 of the head 29, and are for supplying air and water to the air and water port 34 of the head 29.

The tooth-preparation portion 12 further includes a dimension input 46. The dimension input 46 is disposed on the grip 20 of the pistol 18 of the housing 16, is operatively connected to the head 29, inputs horizontal and vertical dimensions to position the head 29, and is preferably digital for easy touch control.

(1) The Filing Bur 30 of the Head 29.

The configuration of the filing bur 30 of the head 29 can best be seen in FIG. 3, which is an enlarged diagrammatic cross sectional view of the area generally enclosed by the dotted curve identified by ARROW 3 in FIG. 2 of the filing bur of the tooth-preparation portion of the dental device of the present invention, and as such, will be discussed with reference thereto.

The filing bur 30 of the head 29 includes a body 48. The body 48 of the filing bur 30 of the head 29 is in a form of an inverted cup 50 having an inner surface 52, an outer surface 53, and a shaft 54, and is made from carbide metal.

The shaft 54 of the filing bur 30 of the head 29 extends upwardly therefrom and engages and rotates by the motor 35 of the head 29.

The inner surface 52 of the body 48 of the filing bur 30 of the head 29 is lined with diamond granules or carbide teeth, and the outer surface 53 of the body 48 of the filing bur 30 of the head 29 is smooth for not damaging teeth adjacent the tooth being filed.

C. The Crown Preparation Portion 14.

The configuration of the crown-preparation portion 14 can best be seen in FIG. 4, which is an enlarged diagrammatic side elevational view of the area generally enclosed by the dotted curve identified by ARROW 4 in FIG. 1 of the crown-preparation portion of the dental device of the present invention for preparing the crown, and as such, will be discussed with reference thereto.

The crown-preparation portion 14 includes an enclosure 56. The enclosure 56 is for standing upright from a floor, and has an upper portion 58 with a front 60 having a control panel 61 thereon, and a lower portion 62 with a front 64 that is open.

The crown-preparation portion 14 further includes a tooth-selection panel 66. The tooth-selection panel 66 is disposed on the control panel 61 of the enclosure 56, is a touch screen, has an array of teeth 68 thereon, and is for entering number of the tooth for which the crown is being prepared by touching an associated tooth of the array of teeth 68 thereon.

The crown-preparation portion 14 further includes a display screen 70. The display screen 70 is further disposed on the control panel 61 of the enclosure 56 and is for displaying input data.

The crown-preparation portion 14 further includes a vertical-dimension-input button 72. The vertical-dimension-input button 72 is further disposed on the control panel 61 of the enclosure 56 and is for inputting vertical dimension.

The crown-preparation portion 14 further includes a horizontal-dimension-input button 74. The horizontal-dimension-input button 74 is further disposed on the control panel 61 of the enclosure 56 and is for inputting horizontal dimension.

The crown-preparation portion 14 further includes an on-off switch 75. The on-off switch 75 is further disposed on the control panel 61 of the enclosure 56 and turns the crown-preparation portion 14 on and off.

The crown-preparation portion 14 further includes an enter button 76. The enter button 76 is further disposed on the control panel 61 and is for entering data inputted.

The crown-preparation portion 14 further includes a base 78. The base 78 is disposed in the front 64 of the lower portion 62 of the enclosure 56 and is for holding the crown being prepared.

The crown-preparation portion 14 further includes a motor 80. The motor 80 is dependingly disposed in the front 64 of the lower portion 62 of the enclosure 56 and is for rotating a tool for trimming the crown.

The crown-preparation portion 14 further includes a heat source 81. The heat source 81 is disposed in the front 64 of the lower portion 62 of the enclosure 56 and is for applying heat during polishing of the crown.

The crown-preparation portion 14 further includes a start button 82. The start button 82 is further disposed on the control panel 61 of the enclosure 56 and selectively activates the motor 80.

The crown-preparation portion 14 further includes a data transmission button 84. The data transmission button 84 is further disposed on the control panel 61 of the enclosure 56, and when activated, causes the crown-prepared-tooth measurements to be received by the crown-preparation portion 14 from the tooth-preparation portion 12.

The crown-preparation portion 14 further includes an input-save button 85. The input-save button 85 is further disposed on the control panel 61 of the enclosure 56, and when activated, saves data inputted.

The crown-preparation portion 14 further includes an output-erase button 87. The output-erase button 87 is further disposed on the control panel 61 of the enclosure 56, and when activated, erases data outputted.

The crown-preparation portion 14 further includes a heat source on-off button 86. The heat source on-off button 86 is further disposed on the control panel 61 of the enclosure 56, and when activated, activates the heat source 81.

The crown-preparation portion 14 further includes a polishing-start button 88. The polishing-start button 88 is further disposed on the control panel 61 of the enclosure 56, and when activated, activates the motor 80.

C. The Method of Utilizing the Dental Device 10.

The method of utilizing the dental device 10 can best be seen in FIGS. 5-7, which are, respectively, is a diagrammatic side elevational view of the separating step of the method of utilizing the dental device of the present invention for preparing the tooth for the crown, a diagrammatic side elevational view of the filing step of the method of utilizing the dental device of the present invention for preparing the tooth for the crown, and, a diagrammatic side elevational view of the cleaning and post preparing steps of the method of utilizing the dental device of the present invention for preparing the tooth for the crown, and as such, will be discussed with reference thereto.

The method of utilizing the dental device 10 comprises the steps of:

STEP 1:

As shown in FIG. 5, separate the tooth to be prepared from both adjacent teeth, thereby freeing the tooth to be prepared from both adjacent teeth.

STEP 2:

Move the horizontal-displacement control 38 of the tooth-preparation portion 12 left and right to measure distance between the tooth to be prepared and both adjacent teeth, thereby forming a horizontal dimension.

STEP 3:

Insert the filing bur 30 of the head 29 of the tooth-preparation portion 12 associated with the horizontal dimension.

STEP 4:

As shown in FIG. 6, start the filing bur 30 of the head 29 filing the tooth.

STEP 5:

Control speed of air and water supplied by the air and water port 34 of the head 29 of the tooth-preparation portion 12 for cleaning and cooling off the tooth to be prepared and the filing bur 30 of the head 29 during filing.

STEP 6:

Activate the dimension input 46 of the tooth-preparation portion 12 to send the crown-prepared-tooth measurements to the crown-preparation portion 14 for preparing the crown.

STEP 7:

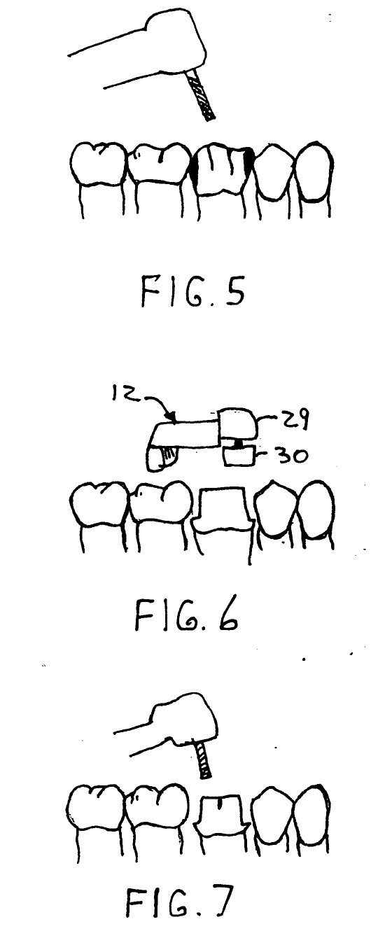

As shown in FIG. 7, clean the crown-prepared tooth and make a post hole in the crown-prepared tooth.

STEP 8:

Place the crown on the base 78 of the crown-preparation portion 14.

STEP 9:

Activate the associated tooth of the array of teeth 68 of the tooth-selection panel 66 of the crown-preparation portion 14.

STEP 10:

Activate the vertical-dimension-input button 56 and the horizontal-dimension-input button 74 of the crown-preparation portion 14.

STEP 11:

Activate the start button 82 of the crown-preparation portion 14, thereby activating the motor 80 of the crown-preparation portion 14 to file the crown, thereby forming a filed crown.

STEP 12:

Activate heat source on-off button 86 of the crown-preparation portion 14 to activate the heat source 81 of the crown-preparation portion 14.

STEP 13:

Activate the polishing-start button 88 of the crown-preparation portion 14 to polish the filed crown, thereby forming a finished crown.

It will be understood that each of the elements described above, or two or more together, may also find a useful application in other types of constructions differing from the types described above.

While the invention has been illustrated and described as embodied in a dental device for preparing a tooth for a crown and for preparing the crown, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A dental device for preparing a tooth for a crown and for preparing the crown, comprising:
a) a tooth-preparation portion; and
b) a crown-preparation portion;
wherein said tooth-preparation portion is for preparing the tooth for the crown, thereby forming a crown-prepared tooth, and thereafter, takes measurements of the crown-prepared tooth, thereby forming crown-prepared-tooth measurements;
wherein said crown-preparation portion is operatively connected to said tooth-preparation portion; and
wherein said crown-preparation portion is for preparing the crown for the crown-prepared tooth based upon the crown-prepared-tooth measurements received from said tooth-preparation portion.

2. The device of claim 1, wherein said tooth-preparation portion includes a housing;
wherein said housing of said tooth-preparation portion is hand-held;
wherein said housing of said tooth-preparation portion is in form of a pistol for easy handling;
wherein said pistol has a grip;
wherein said pistol has a barrel;
wherein said pistol has a trigger;
wherein said trigger of said pistol is operatively connected to said grip of said pistol;
wherein said barrel of said pistol has a proximal end;
wherein said grip of said pistol extends from said proximal end of said barrel of said pistol; and
wherein said barrel of said pistol has a distal end.

3. The device of claim 2, wherein said tooth-preparation portion includes a head; and
wherein said head is at said distal end of said barrel of said pistol.

4. The device of claim 3, wherein said head includes a filing bur;
wherein said filing bur of said head is contained dependingly there; and
wherein said filing bur of said head is for receiving and preparing the tooth for the crown.

5. The device of claim 4, wherein said head includes a cover;
wherein said cover of said head is contained dependingly therein;
wherein said cover of said head surrounds said filing bur of said head; and
wherein said cover of said head is for containing filings from said filing bur of said head during filing.

6. The device of claim 5, wherein said cover of said head is transparent for allowing sight of said filing bur of said head during filing.

7. The device of claim 5, wherein said head includes an air and water port;
wherein said air and water port of said head is contained dependingly therein;
wherein said air and water port of said head is interposed between said cover of said head and said filing bur of said head; and
wherein said air and water port of said head is for supplying air and water to clean and cool the tooth being prepared and said filing bur of said head during filing.

8. The device of claim 7, wherein said air and water port of said head is forward of said filing bur of said head.

9. The device of claim 7, wherein said head includes a motor;
wherein said motor of said head is contained therein; and
wherein said motor of said head is operatively connected to said filing bur of said head to rotate said filing bur of said head.

10. The device of claim 4, wherein said tooth-preparation portion includes a vertical-displacement control;
wherein said vertical-displacement control controls vertical displacement of said head and associated measurement; and
wherein said vertical-displacement control is disposed vertically on said head.

11. The device of claim 4, wherein said tooth preparation portion includes a horizontal-displacement control;
wherein said horizontal-displacement control controls horizontal displacement of said head and associated measurement; and
wherein said horizontal-displacement control is disposed horizontally from said head.

12. The device of claim 5, wherein said head includes a light;
wherein said light of said head is contained dependingly therein;
wherein said light of said head is interposed between said cover of said head and said filing bur of said head; and
wherein said light of said head illuminates said filing bur of said head.

13. The device of claim 12, wherein said light of said head is rearward of said filing bur of said head.

14. The device of claim 4, wherein said tooth-preparation portion includes a jaw-selection control;
wherein said jaw-selection control is operatively connected to said head;
wherein said jaw-selection control causes said head to selectively invert for treating top and bottom teeth; and
wherein said jaw-selection control is controlled by said trigger of said pistol, which when squeezed, frees said heads for inversion, and which when released, locks said head in position.

15. The device of claim 9, wherein said tooth-preparation portion includes cables;
wherein said cables depend from said grip of said pistol;
wherein said cables are operatively connected to said crown-preparation portion to transmit the crown-prepared-tooth measurements thereto from said tooth-preparation portion;
wherein said cables are for supplying electricity to said motor of said head; and
wherein said cables are for supply air and water to said air and water port of said head.

16. The device of claim 4, wherein said tooth-preparation portion includes a dimension input;
wherein said dimension-input is disposed on said grip of said housing;
wherein said dimension-input is operatively connected to said head; and
wherein said dimension-input inputs horizontal and vertical dimensions to position said head.

17. The device of claim 16, wherein said dimension input is digital for easy touch control.

18. The device of claim 9, wherein said filing bur of said head includes a body;
wherein said body of said filing bur of said head is in a form of an inverted cup;
wherein said body of said filing bur of said head has an inner surface;
wherein said body of said filing bur of said head has an outer surface; and
wherein said body of said filing bur of said head has a shaft.

19. The device of claim 18, wherein said body of said filing bur of said head is made from carbide metal.

20. The device of claim 18, wherein said shaft of said filing bur of said head extends upwardly therefrom;
wherein said shaft of said filing bur of said head engages said motor of said head;
and
wherein said shaft of said filing bur of said head rotates by said motor of said head.

21. The device of claim 18, wherein said inner surface of said body of said filing bur of said head is lined with one of diamond granules and carbide teeth.

22. The device of claim 18, wherein said outer surface of said body of said filing bur of said head is smooth for not damaging teeth adjacent the tooth being filed.

23. The device of claim 1, wherein said crown preparation portion includes an enclosure;
wherein said enclosure is for standing upright from a floor;
wherein said enclosure has an upper portion;
wherein said upper portion of said enclosure has a front;
wherein said front of said upper portion of enclosure has a control panel thereon;
wherein said enclosure has a lower portion; and
wherein sad lower portion of said enclosure has a front.

24. The device of claim 23, wherein said crown-preparation portion includes a tooth-selection panel;
wherein said tooth-selection panel is disposed on said control panel of said enclosure;
wherein said tooth-selection panel has an array of teeth thereon; and
wherein said tooth-selection panel is for entering number of the tooth for which the crown is being prepared.

25. The device of claim 24, wherein said tooth-selection panel is a touch screen so as to allow the number of the tooth for which the crown is being prepared to be entered by touching an associated tooth of said array of teeth the thereon.

26. The device of claim 23, wherein said crown-preparation portion includes a display screen;
wherein said display screen is disposed on said control panel of said enclosure; and
wherein-said display screen is for displaying input data.

27. The device of claim 23, wherein said crown-preparation portion includes a vertical-dimension-input button;
wherein said vertical-dimension-input button is disposed on said control panel of said enclosure; and
wherein said vertical-dimension-input button is for inputting vertical dimension.

28. The device of claim 23, wherein said crown-preparation portion includes a horizontal-dimension-input button;
wherein said horizontal-dimension-input button is disposed on said control panel of said enclosure; and
wherein said horizontal-dimension-input button is for inputting horizontal dimension.

29. The device of claim 23, wherein said crown-preparation portion includes an on-off switch;
wherein said on-off switch is disposed on said control panel of said enclosure; and
wherein said on-off switch turns said crown-preparation portion on and off.

30. The device of claim 23, wherein said crown-preparation portion includes an enter button;
wherein said enter button is disposed on said control panel of said enclosure; and
wherein said enter button is for entering data inputted.

31. The device of claim 23, wherein said crown preparation-portion includes a base;
wherein said base is disposed in said front of said lower portion of said enclosure;
and
wherein said base is for holding the crown being prepared.

32. The device of claim 23, wherein said crown-preparation portion includes a motor;
wherein said motor is dependingly disposed in said front of said lower portion of said enclosure; and
wherein said motor is for rotating a tool for trimming the crown.

33. The device of claim 23, wherein said crown-preparation portion includes a heat source;
wherein said heat source is disposed in said front of said lower portion of said enclosure; and
wherein said heat source is for applying heat during polishing of the crown.

34. The device of claim 32, wherein said crown-preparation portion includes a start button;
wherein said start button is disposed on said control panel of said enclosure; and
wherein said start button selectively activates said motor.

35. The device of claim 23, wherein said crown-preparation portion includes a data-transmission button; and
wherein said data-transmission button is disposed on said control panel of said enclosure, and when activated, causes the crown-prepared-tooth measurements to be received by said crown-preparation portion from said tooth-preparation portion.

36. The device of claim 23, wherein said crown-preparation portion includes an input-save button; and
wherein said input-save button is disposed on said control panel of said enclosure, and when activated, saves data inputted.

37. The device of claim 23, wherein said crown-preparation portion includes an output-erase button; and
wherein said output-erase button is disposed on said control panel of said enclosure, and when activated, erases data outputted.

38. The device of claim 33, wherein said crown-preparation portion includes a heat source on-off button; and
wherein said heat source on-off button is disposed on said control panel of said enclosure, and when activated, activates said heat source.

39. The device of claim 32, wherein said crown-preparation portion includes a polishing-start button; and
wherein said polishing-start button is disposed on said control panel of said enclosure, and when activated, activates said motor.

40. A method of utilizing a dental device for preparing a tooth for a crown and for preparing the crown, wherein the dental device has a tooth-preparation portion for preparing the tooth for the crown and a crown-preparation portion for preparing the crown, said method comprising the steps of:
a) separating the tooth to be prepared from both adjacent teeth, thereby freeing the tooth to be prepared from both adjacent teeth;
b) moving a horizontal-displacement control of the tooth-preparation portion left and right to measure distance between the tooth to be prepared and both adjacent teeth, thereby forming a horizontal dimension;
c) inserting a filing bur of a head of the tooth-preparation portion associated with the horizontal dimension;
d) starting the filing bur of the head filing the tooth;
e) controlling speed of air and water supplied by an air and water port of the head of the tooth-preparation portion for cleaning and cooling off the tooth being prepared and the filing bur of the head during filing;
f) activating a dimension input of the tooth-preparation portion to send crown-prepared-tooth measurements to the crown-preparation portion for preparing the crown;
g) cleaning the crown-prepared tooth; and
h) making a post hole in the crown-prepared tooth.

41. The method of claim 40, further comprising the steps of:
i) placing the crown on a base of the crown-preparation portion;
j) activating an associated tooth of an array of teeth of a tooth-selection panel of the crown-preparation portion;
k) activating a vertical-dimension-input button and a horizontal-dimension-input button of the crown-preparation portion;
l) activating a start button of the crown-preparation portion, thereby activating a motor of the crown-preparation portion to file the crown, thereby forming a filed crown;
m) activating a heat source on-off button of the crown-preparation portion to activate a heat source of the crown-preparation portion; and
n) activating a polishing-start button of the crown-preparation portion to polish the filed crown, thereby forming a finished crown.
